(19) United States
(12) Patent Application Publication
(10) Pub. No.: US 2017/0323543 A1
(43) Pub. Date: Nov. 9, 2017

(54) VIDEO IMAGE VERIFICATION SYSTEM UTILIZING INTEGRATED WIRELESS ROUTER AND WIRE-BASED COMMUNICATIONS

(71) Applicant: Lawrence F Glaser, Windermere, FL (US)

(72) Inventor: Lawrence F Glaser, Windermere, FL (US)

(21) Appl. No.: 15/303,005

(22) PCT Filed: Apr. 7, 2015
(86) PCT No.: PCT/US2015/024722

§ 371 Date: Oct. 9, 2016

Related U.S. Application Data
(60) Provisional application No. 61/977,010, filed on Apr. 8, 2014.

(51) Int. Cl. G08B 13/196; G06F 17/30; G06T 1/00; H04N 7/18; G08B 29/04

(52) U.S. Cl. CPC G08B 13/19673; H04N 7/181; G08B 29/046; G06F 17/30047; G06T 1/0021; G08B 13/19656

(57) ABSTRACT

A system and methods of digital image capture, video surveillance and, in particular, to a method for verification of integrity and validity of live or recorded images, video(s) and surveillance images and video(s), both real-time and delayed. The method, in accordance with a principle embodiment, employs the use of additional light (photonic water marks) added to images of objects and scenes The photonic water marks reflect or refract, scatter or entangle with the real objects and scenes to then be digitized with the object or scene image.

### BACKGROUND

The present invention is related to methods of digital image capture, video surveillance and, in particular, to a method for verification of integrity and validity of live or recorded images, video(s) and surveillance images and video(s), both real-time and delayed.

Digital image capture, video image capture and their further use in applications such as surveillance, is currently one of the fastest growing applications of digital video and data networking. Conventional video surveillance systems employ CCTV (Closed Circuit Television) equipment that does not have the efficiency and security of digital technologies. Transitioning the entire system into the digital domain often comes with increases in efficiency and cost benefits. Typically, digital video surveillance systems employ mainstream TCP/IP and Ethernet data communications standards, allowing to find adequate digital equivalents to the past and present analog architectures and to take advantage of the added levels of versatility that digital technology offers. The digital surveillance systems improve upon the efficiency of conventional systems and provide additional improvement in the level of security. However, digital surveillance systems impose a number of challenges that need to be addressed.

Implementation of an all-digital video security system involves finding ways to improve the system security while maintaining its affordability. However, once a digital video system becomes a key component of a physical security of a site, it can no longer be assumed that the surveillance video feeds are unaltered or not tampered with. Conventional video surveillance (i.e., CCTV) has been an important security tool in both private corporate and public government sectors. Video surveillance technology is currently evolving from entirely analogue systems on to hybrid analogue-digital systems and ultimately to all-digital IP-network based configurations. Conventional analogue CCTV systems consist of analogue cameras, display monitors and video cassette recorders.

In modern hybrid systems, the VCRs are replaced with a digital recording system utilizing digital components that digitize and compress the video signal and store it onto computer hard disks or other digital media. Some hybrid video surveillance systems have their display monitors fed from the digital recorders rather than from the analog source or from a digital camera source. Such a security system displays a digitized video stream on the observation monitors. In this case, the digital recording system replaces the analog video routing switches, hubs, transceivers and as well, the VCR(s).

Ultimately, the market exhibits an obvious trend towards an all-digital Internet Protocol (IP)-based network supplanting classic CCTV systems, where video digitization and compression are performed within a digital camera and communicated to the needed monitoring locations and centralized or distributed storage devices. The imminent transition to an all-digital IP-based digital video surveillance system has a potential for reducing equipment and maintenance costs while increasing the value of the system and providing improved security.

However, transition to an all-digital system creates new types of vulnerabilities and weaknesses that need to be identified and mitigated. For example, the following issues can affect digital video surveillance system(s). A deliberate attack on a security video system can include a deliberate insertion of false imagery and disabling of certain system components. The insertion of the false imagery can be performed at one of many points in the system:

(a) a still picture in printed form, or on a screen as a projection, can be placed in front of the camera lens that resembles the observed scene, to simulate inactivity;

(b) previously recorded images that form a given scene are fed in a “loop” into the system, instead of the actual live video signal;

(c) display monitors located in the security monitoring center can be re-routed to display a pre-recorded video instead of a live video feed;

(d) a security video monitor can be reconfigured for viewing unrelated video content;

(e) a digital recording file can be replaced by a file generated before or after an intrusion event, possibly, with a counterfeit time date stamp;

(f) using hacking, viruses, breaches in fire wall protection, intrusion into the network either through the internet or any other network based pathway, also to include direct attachment to a device such as a USB plug into a server, the system can simply be interrupted and images deformed, to where the site would benefit from the most rapid alarm to report and automatically stop this event which includes making sure if a *hacker* attempts to disable internal alarms so as to do as much damage as possible, to identify this deep of a level intrusion event.

Additionally, any technical malfunctions can result in some of the above scenarios. Regardless of the nature of these occurrences, they need to be automatically detected and done so in real time. The detection is preferred if it is intelligent, in that it does not generate unnecessary false alarms.

Security is known in the art of networked video cameras, such as U.S. Pat. No. 8,364,956 (Ju) which compares the user access authority level and the access authority level assigned to the specific image data, and based on comparison result thereof, selectively provides the specific image data to the user, but without verification of a digital video or image. Also, U.S. Pat. No. 7,614,065 (Weissmueller) uses codes, but fails to extend to a variety of pre-selected pixel-wise patterns in images and is directed to broadcast content verification, rather than CCTV.

Other examples exist such as US#2010/0033575, (Lee) which represent some refinements in security monitoring, but requiring additional personnel to supply the verification steps.

Accordingly, there is a need in the art for a cost-effective method for verification of a digital video or image. Such method should include inserting certain distinguishable and difficult to imitate characteristics into the actual source of the picture or video, literally, add data to the very image to be taken before it is taken. There is further a need to allow for a variety of pre-selected pixel-wise patterns in images including differences extending to per image, per video, per frame, images not visible to the human eye or specific to cameras and monitors being used, and a data base matching the pattern to date and time, thus verifying with great certainty the content.

### SUMMARY OF THE INVENTION

A physical security system must be protected from tamper or sabotage without imposing additional expenses in its implementation. And these means are best deployed as artificially intelligent automatic mechanisms so a wholesale attack on a site can be known in real time. Ideally, the use of systems not attached to public networks add some protection levels to protect from outside attack, hacking and the use of viruses.

The present invention is related to methods of digital video surveillance and, in particular, to a method for verification of integrity and validity of surveillance—live or recorded video and still digital images. Logically, this will also apply to non surveillance applications and although these may not be discussed in detail, one of skill having reviewed this disclosure and associated figures, will easily and readily understand all of the intended branch applications. Rough examples include use in making movies, advertisements, still image and videos for personal use from cameras and video recorders, portable devices such as cell and tablet equipped to act as a camera or video recorder. The method, in accordance with a principle embodiment, employs the use of additional light added to objects and scenes to be captured just before they are captured. These additional light-based superimposed images (photonic water mark, hereinafter referenced as [PWM]s) are anticipated to reflect or refract, scatter or entangle with the real objects and scenes to then be digitized with the object or scene image and may take the form of light below the visible spectrum, light in the visible spectrum and light above the visible spectrum. Nothing contained herein is intended to limit the use of multi-spectral PWMs which can be coherent, monochrome or multi-spectral to any logical limit.

It is an object of the present invention to exploit redundancy opportunities through which new forms of encryption can be introduced to further “harden” a security system

Entanglement data implies specifically that the light source used for verification may include coherent light which is entangled and contains information which may be retrieved from the reflected and captured image, to further verify the veracity of the captured image. In an embodiment, objects in the field of view are created which emit quantum entangled particles. To the extent these emissions are in accordance with some known, decipherable communications schema, the servers and cameras capable of QED communications could detect these specific emissions assisting further in assuring a given still or video image is verified and true, not corrupted in any manner by an evil doer, public enemy, hacker or enemy of the state.

It is a principle object of the present invention for the cameras themselves to be used for a number of purposes, one of which is to act as the verification light source, either through an adjunct contained in the same housing or, alternatively, a chip which functions as the inbound an outbound communications and signaling source

It is an object of the present invention to deploy the same technique applied to the topologic design for remote access devices

It is an object of the present invention to provide a special software module within any servers serving the security network (or servers station on networks for public or private use) to calculate the presence of or absence of the PWMs, providing needed confirmations and alarms in real time.

It is a further object of the present invention for the monitors themselves to either be able or unable to display all the pixels making up the combined image or video with its PWMs

It is a further object of the present invention to provide a closed CCTV system (C-CCTV) to watch the monitors the security staff watch, to check and verify the PWMs are present and correct, correlated and time date correct simply by reaching into the master verification data base and performing the comparison but from a visibly acquired new recording taken from the very screen the security staff use, rather than to perform this task from any point within the cctv security system.

It is a further object of the present invention to allow the router to be a Wi Fi and to generate multiple Wi Fi connection types which work simultaneously.

For purposes of the present unit, a “guard interface unit” refers to an output device, which may have a video display, for providing information to security personnel.

### BRIEF DESCRIPTION OF DRAWINGS

FIG. 1 shows a series of cameras 100 having embedded wi fi routers, in accordance with the present invention.

FIG. 2 shows a series of cameras 100 of the invention as depicted in FIG. 1, further equipped, in an embodient, with a verification light source 200 and other features.

FIG. 3 shows a stand-alone verification light source 300 emitting the verification light signal 310.

FIG. 4 shows a standard computer monitor having, in an embodiment, PWM data 410 and hand held portable device 401 displaying PWM data, 410.

FIG. 5 shows topology according to some of the embodiments of the invention Including networks having main 503 and control or verification 504 servers.

FIG. 6 shows, in embodiments, two servers, 503 and 504 combined into one single server and alternately, servers maintained as separate.

FIG. 7 shows, in an embodiment, hard ports on the wi fi routers 111 deployed to monitor object 700 with ultra high security.

FIG. 8 shows a limited embodiment of the verification scheme of FIG. 7, routing images frame by frame to central security equipment for preventing the introduction of false frames.

FIG. 9 shows a block diagram for a method of operation of the arrangements of the previous figures.

FIG. 10 shows flowcharts for methods of operation of the arrangements of the previous figures.

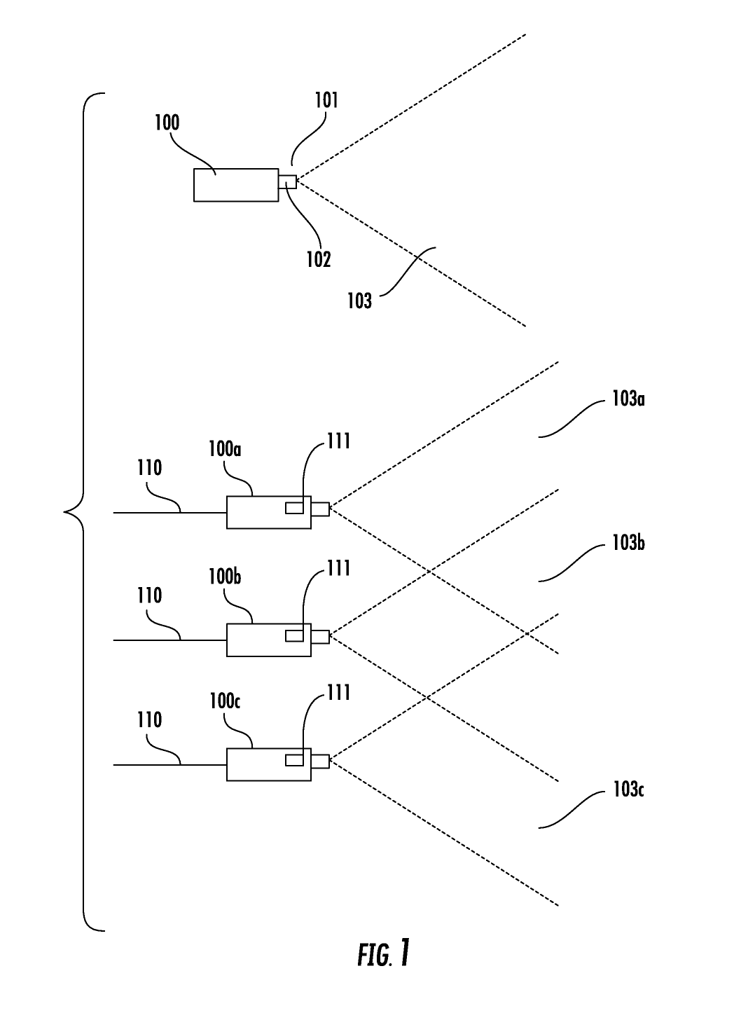

Referring to FIG. 1, a camera 100 is depicted, its lens (analog) 101, the ccd chip itself 102 and the field of view 103. An embedded wi fi router 111 is shown in each of cameras 100a, b and c, depicted as routers 111. The fields of view for each camera are depicted as fields of view 101-103 a, b and c. Cable attachments to the cameras are shown as 110 and could be fiber optic or copper, CAT 5, 6, 7 with or without POE (Power Over Ethernet) or an external power adaptor (not shown) and with or without extra batteries in all these devices (also not shown)

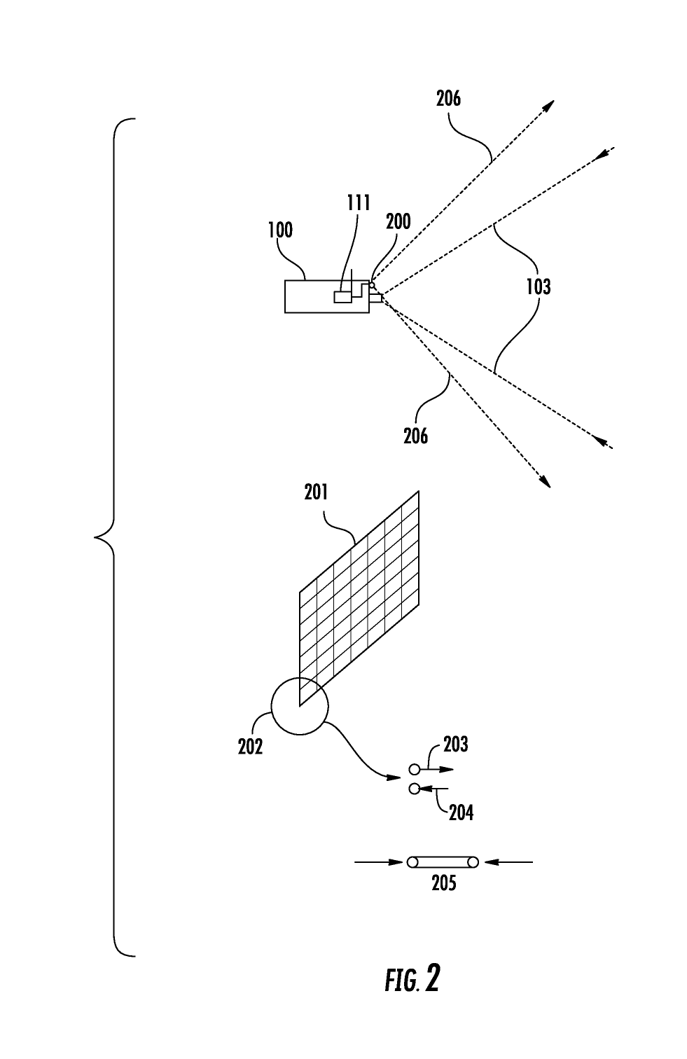

Referring to FIG. 2 a camera 100 is depicted, equipped, in an embodiment of the present invention, with a verification light source 200. Also shown is ccd chip 201 and a portion of the chip, 202, which can comprise pixels which emit light 203, or pixels which collect light 204, or both, in arrays or in stacks. An analog lens (not shown) and wave guides 205 which function as pinhole lenses can be strategically placed within a design to better guide the photons in or out, as desired, to generate very specific desired effects. 206 is the maximum projection field of the verification light source. (PWM source)

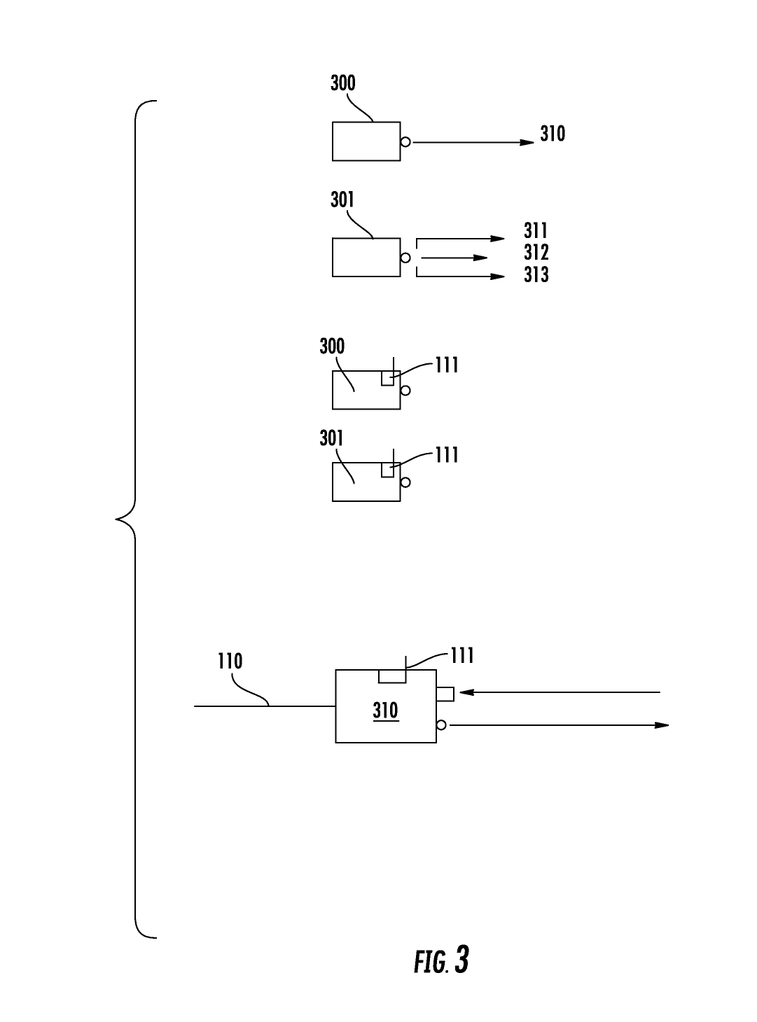

Referring to FIG. 3, a stand-alone verification light source 300 is shown emitting the verification light signal 310. 301 is also a stand-alone light source capable of emitting a more complex signal in multi-frequency light bands shown as frequencies (photon wave lengths) 311, 312 and 313 which could be three different colors of light. The colors can be so close that the human eye could not detect the difference, and they can be above, within or below the visible spectrum. A camera 100, with router 111, and verification light source as an integrated component is shown as 310.

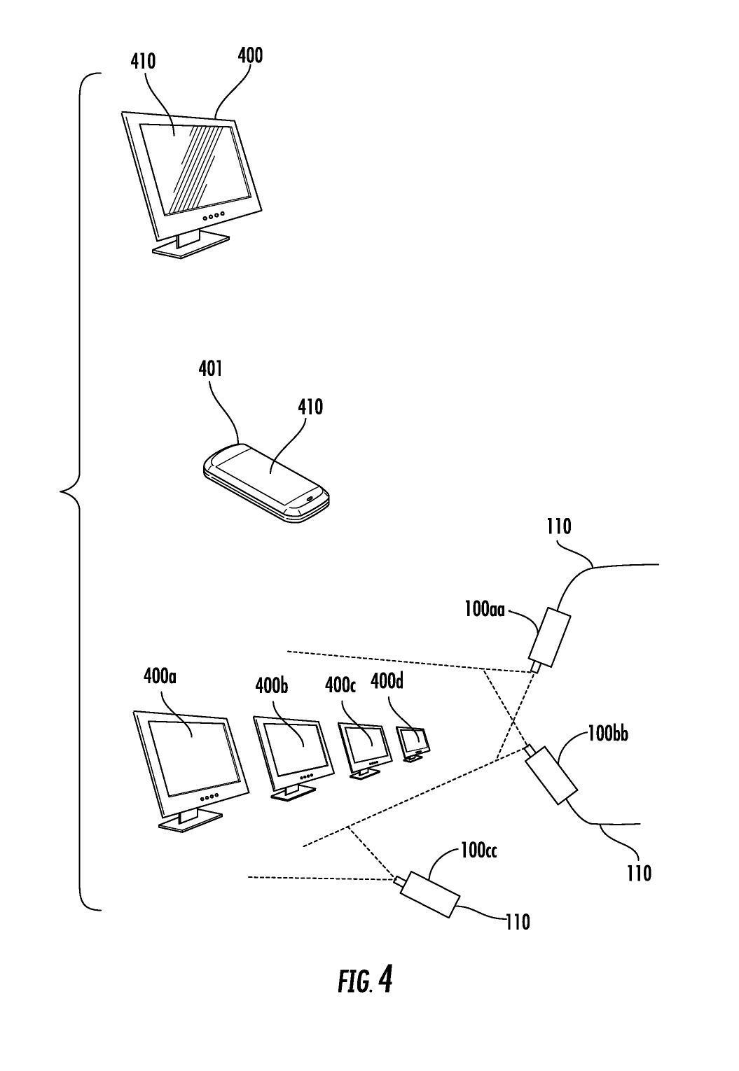

Referring to FIG. 4, a standard computer monitor is shown, a basic flat screen model, 400. Within a displayed image or video, the PWM data can be present shown as 410. A hand held portable device is shown, such as a cell phone, 401 and it also shows PWM data, 410. A plurality of flat screen monitors are shown 400 a, b, c, d and verification cctv cameras as 100 aa, bb, cc not to be confused with the cameras of FIG. 1. Although cables are shown as 110, they need not be part of the cctv network, and may be isolated in their own network. The cameras may be equipped with all the features of camera 100 so as to build in the same security measures into the verification system as are found in the cctv security system. Hence, yet another layer of CCTV cameras could be provided (not shown) to protect the verification cctv system. Nothing herein is intended to limit the number of systems used to verify one another, either one on top of the other, or ultimately forming a logical mesh.

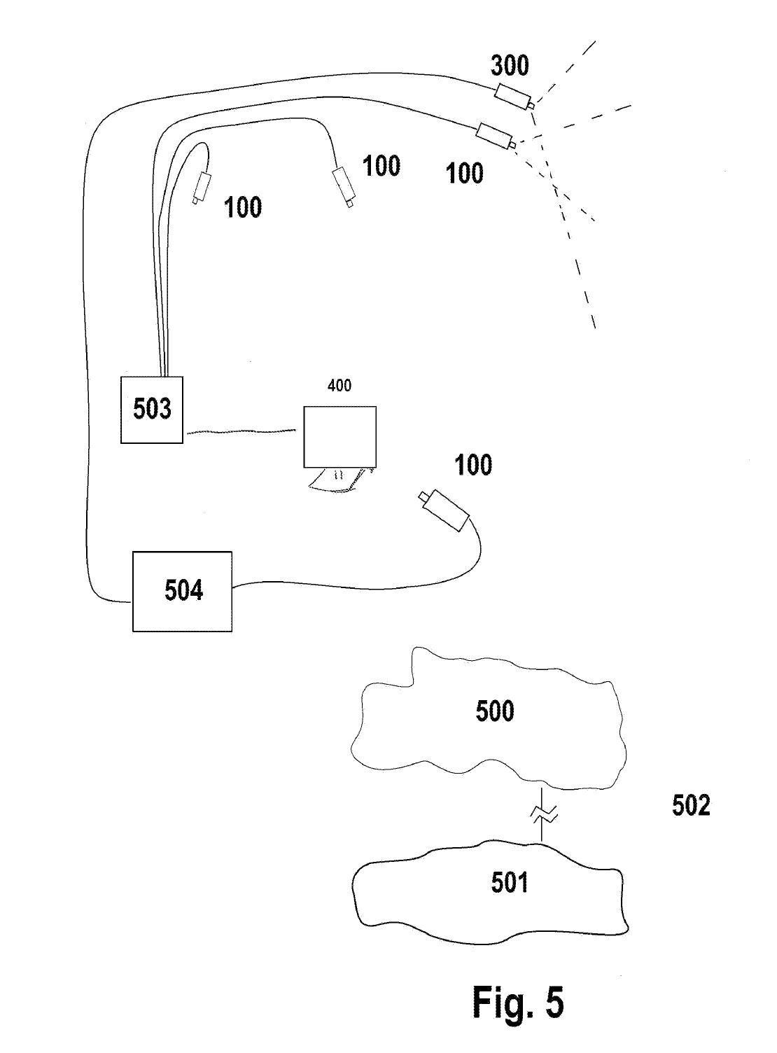

Referring to FIG. 5 some basic logical topologies are shown, according to some of the embodiments of the invention. A network centering on DVR server 503 is shown, while another network centering on control or verification server 504 is shown. Server 503 would be at the logical center of network 500 and server 504 would be at the logical center of network 501. The broad concept of no wireless or wire based crossing of the two networks is loosely shown as 502.

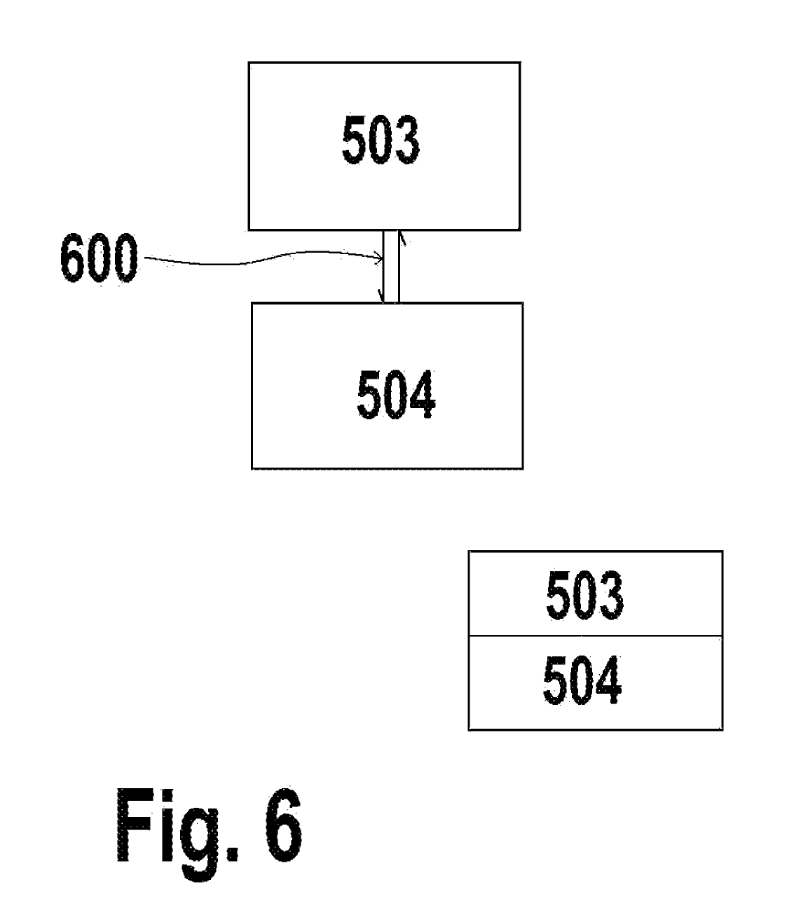

Referring to FIG. 6, two servers, DVR server 503 and verification server 504 are shown combined into one, single server. It also shows the servers maintained as separate, which, in an embodiment, host a link, 600, between them. Not shown are all the precautions taken when the link is established, such as to block the internet if it is present on one server, from accessing in any manner or form, the other server not intended to have internet connectivity or attachment (communications of any kind to or from the internet).

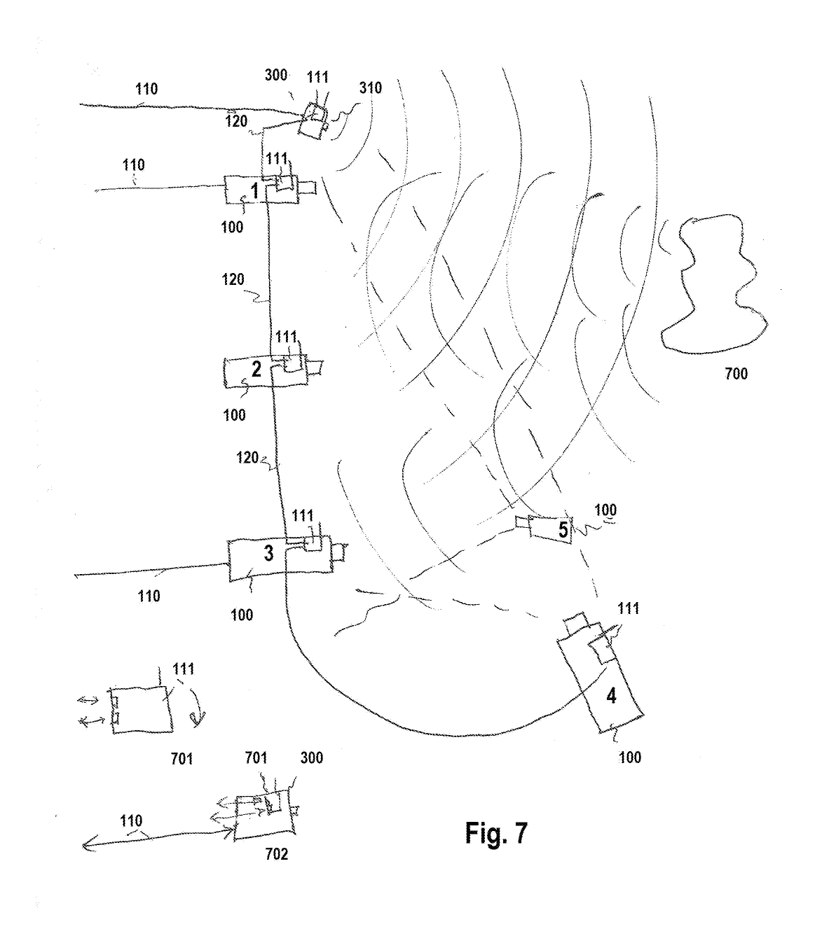

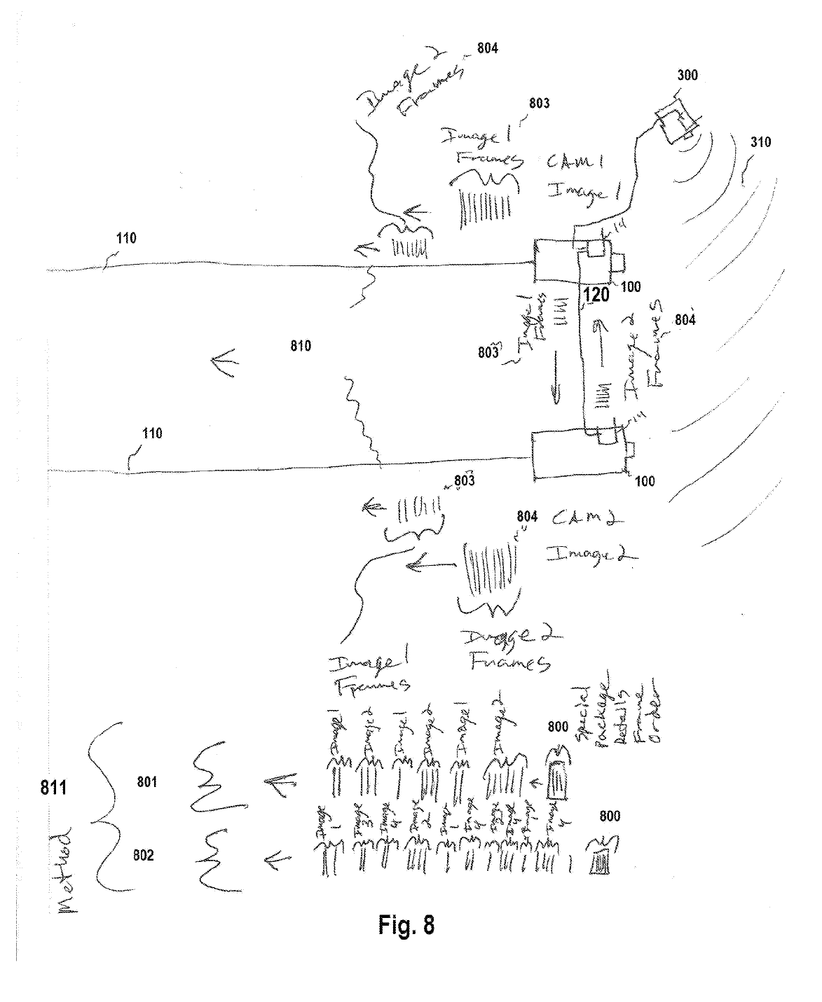

Referring to FIG. 7, the idea, in accordance with the present invention, of hard ports on the wi fi routers 111 is shown, creating a wi fi router with hard ports 701 and a stand alone light verification source 300 but with the wi fi router and hard ports which we label 702. In this figure, a complex scheme is deployed to monitor object 700 with ultra high security and high certainty as to the image validity, downstream at the DVR and security monitoring stations. Not shown is the potential extra cameras and isolated network between those cameras which can verify what is shown in the security screens is precisely what the cameras cams 1, 2, 3 4 and 5 captured. A feature of most DVRs allows for creation of a virtual space over an object which is fixed at all times so that an alarm can be raised if any object blocks the view in the box or tries to enter the box domain, such as a human hand. FIG. 7 strategically arranges the cams so that with the right lenses, all watch each other in a closed loop scenario. Multiple intelligent loops are created to assure the cameras are never tampered with, to assure tapping into any one cable or even two, is going to trip an alarm and, that there is no simple or available way to send in a false image without tripping a very specific, real time alarm. These assure the system, outside of controlled space, is very hard to trick, defeat, damage or defraud. More on this subject is covered in FIG. 8.

Referring to FIG. 8, 2 cameras 100 and one light source 300 are shown, Although only 2 are shown, the scheme to route images frame by frame to the central security equipment such as the security monitoring and DVRs, is highly randomized, complex and thus extremely difficult to preemptively tap into to introduce false frames. Randomized but recorded order Frame swapping is performed so that the frame order is constantly shifting. The cams themselves or even light verification source 300 can generate an encrypted key to tell the central equipment the method used to scramble the frames, preemptively or post scramble, close in time enough to effectively randomize the frames but assemble them properly at the main security equipment. The arrangement shows cable based connectivity to the main security equipment 110, interconnecting cables between cams 120 and light verification source 300 and then the figure explores the frame pathway(s) which can be used to reach the main security equipment, with both redundancy, randomization schemes and nothing shown precludes (a not shown) methods to further encrypt the data, including DOD approved methods of encryption so as to still maintain compatibility with the Defense Departments attempts to thwart enemies of our Country and People. Camera 1 images 803 (frames of) and camera 2 images 804 (frames of) are shown as to how a non frame randomized scheme could be sent to the main security equipment marked as Method 810. Camera 1 images 803 (frames of) and camera 2 images 804 (frames of) are shown as to how a frame randomized scheme could be sent to the main security equipment marked as Method 811, which omits the diversification method of Method 810, but could also incorporate it.

Data package (data burst or block) 800 will be encrypted with off the shelf encryption software, which further contained another encrypted message that tells the order of the frames either just before the data package or following the frames to which it applies. It is rotated very frequently. It can also optionally un-encrypt beyond frames, into the pixel by pixel level. 801 depicts any Pathway to the security equipment or from camera to camera, depicting how the order of frames and the special packet 800 could be randomized. 802 shows a redundant pathway to 801 which can send the frames in a different randomization scheme, to the security equipment or from camera to camera, depicting how the order of frames and the special packet 800 could be randomized.

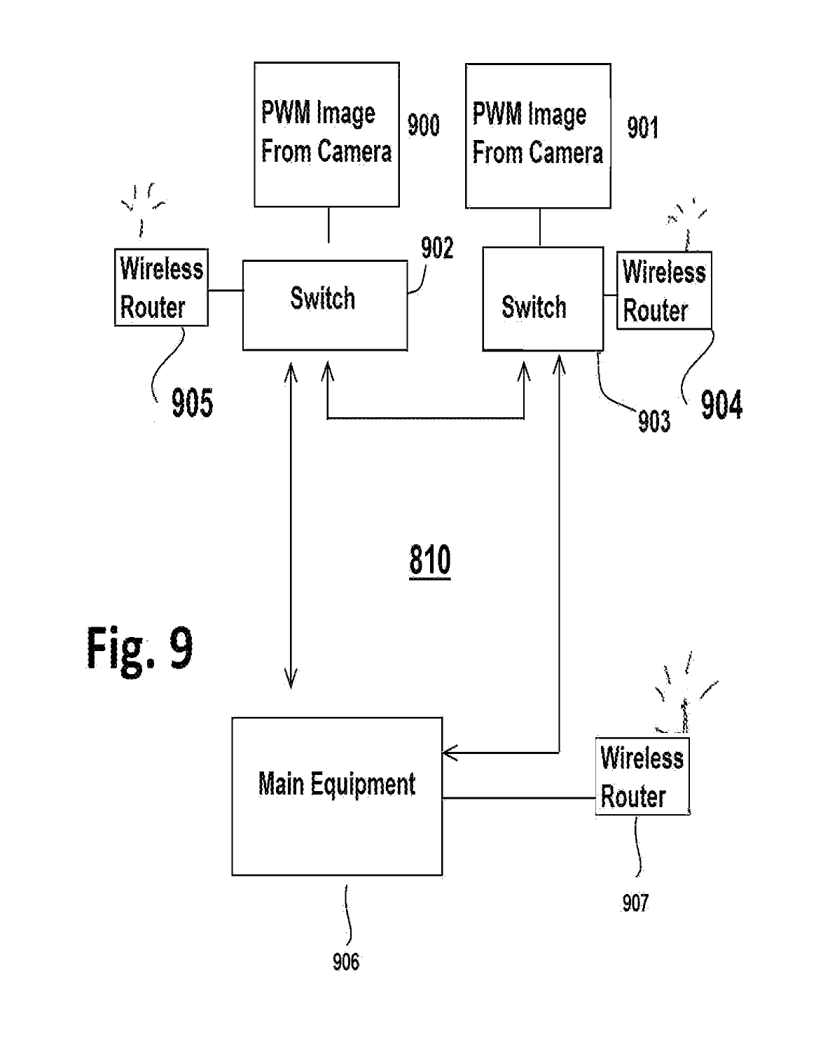

Referring to FIG. 9. two different but related methods are show, method 810 and 811. Method 810 allows image data to flow from the camera 900 which includes any photonic water mark (PWM) data converged with the normal image data to a data switch 902 which in turn may be cabled with metallic cabling or fiber optic cabling to another switch 903, a plurality of switches(not shown) and the main equipment 906. Wireless routers 904 and 905 can send their data to the main equipment 906 through wireless router 907. Typically, the main equipment is a digital video recorder as described elsewhere in this specification.

Method 811 is a repeat of method 810 with some distinct differences in the data distribution and flow. 810 is intended to send the video image combined with PWM redundantly through any pathway available between the cameras 900, 901, and the main equipment 906. The difference is the distribution of the data can be broken into frames, bytes, bits and the information may be parsed and encrypted with any method suitable for protecting the data. The key distinguishing factor between method 810 and 811 is the full image with PWM is never send down any one pathway in whole, only in part.

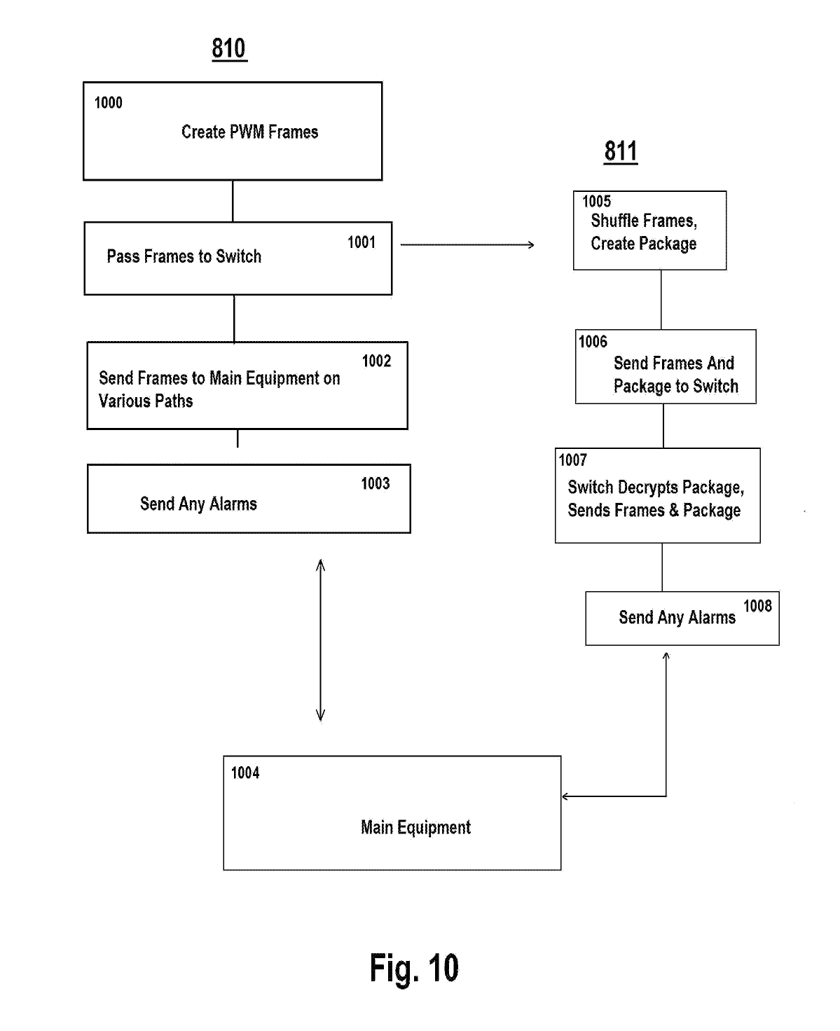

FIG. 10 expands on the functional differences between methods 810 and 811. With method 810, the whole image complete with PWM is sent redundantly to the main equipment 1004. The first step 1000 allows said image data to pass from the camera in question to the switch. The next step 1001 under method 810 passes the image data keeping the frames orderly to the data switch. The next step 1002 copies the data sending three identical streams each down one of 2 wire paths and the third down a wireless pathway labeled WiFi. The next step 1003 notes that alarms travel down the same routes. The cameras can send alarms to the main equipment 1004 and since all the data paths are bidirectional, the main equipment c1004 an send alarms to the cameras as well.

With method 811 Steps 1000 and 1001 are repeated identically to method 810, however the next step under method 811 is step 1005 where image frames are able to be shuffled according to a planned and known method and reconstructed at the main equipment 1004. A special data package is also embedded into the stream which may be identified and removed at the main equipment 1004. Step 1006 passes along all data from the camera to the switch. The next Step 1007 shows the switch deciding which packets to send down which pathway differing from Step 1002 in that the data on any one pathway is not the complete data to form the image, however, the data to form the image arrives at the main equipment 1004—3 times over (3 full images with PWM are received), but distributed across the 3 data pathways according to a predetermine scheme. No single pathway contains all of a single data stream. Step 1008 simply notes that alarms can be sent in similar manner on the same pathways.

In embodiments, the present invention exploits redundancy opportunities through which new forms of encryption can be introduced to further “harden” a security system, and as the herein contained methods are compatible with these means, they will be further enhanced through these redundancy opportunities in the topology, hardware and software. In embodiments, the cameras themselves are used for a number of purposes, one of which is to act as the verification light source, either through an adjunct contained in the same housing, or, a chip which functions as the inbound an outbound communications and signaling source, which indeed may be a combination ccd, digital projector, pinhole wave guides and lenses, a bona-fide QED (Quantum Entanglement Device) which implies creation of, emission of and then, collection of quantum entangled particles, such as photons, with a complete ability to perform the final decryption and verification, within the camera. Alternatively, some or all of the decryption and verification functions can be instead performed by servers or there can be a hybrid solution where the cameras and the servers perform any amount of verification the design requires, up to and including dual, redundant verification with watch dog and check sum functions. Eg the servers and cameras both, independently perform these analysis and compare their results, trip alarms and assure each and every image or video is verified and true, not clandestinely manipulated.

It may be preferable, in order to assure secure communications to and from the verification server, for remote access devices such as cell phones and tablets, or remote sessions using a remote client, to receive a water mark or other indicator which assures, at the verification server, the image being ported remotely, has been verified to contain the PWM 900. Another water mark, icon or sufficient indicator can be provided to assure the image being ported out, has been verified to be authentic.

In an embodiment, the same technique applied to the topologic design is deployed for remote access devices, wherein the remote access device must attach to the verification server using at least two different pathways so each pathway can be used redundantly to port information to the remote access device and assure, what the device can view as a still image or video, is verified authentic.

It is preferable, in cases where cameras which show a field of view that is blank (which, by way of example, may occur in an outdoor setting, in the case of an extreme fog condition, for the camera to be equipped with a micro reflector, or a separate microreflector implemented so that the verification light source can reflect some of the PWM to the camera even when there is no object in the field of view, precisely what fog can produce in terms of a precondition. In this specific setting, the timing of the PWM becomes more desirable than the light frequency or any multi-frequency pattern as the reflector will be designed to reflect a given frequency or frequency range sufficient to verify authenticity of the image. It may be preferable for the lens provided as a part of a typical CCTV camera is caused to emit its own unique signature which manifests as a fixed PWM superimposed on the additional PWM provided by this overall solution. As such, for a public enemy or wrong-doer to emulate the image or video data, they would have to know both the output of the verification light source and the camera lens unique fixed PWM. This also guards from internal attempts to modify a camera by changing its lens, as we would know and could trip an alarm if a lens is removed or replaced and the user did not request this change. Eg or if a whole camera were swapped as part of an internal espionage attempt. Mere loss of communications on any one connection can trip alarms and raise suspicions, however, a change in fixed PWM for a camera or its lens, would certainly raise multiple concerns and can raise its own unique alarm.

In an embodiment, special software module within any servers serving the security network (or servers station on networks for public or private use) is used to calculate the presence of or absence of the PWMs, providing needed confirmations and alarms in real time. These software modules, particularly used to detect the presence of absence of the PWM, could also conceivably preside is client side software, but they would need constant streaming updates from a server to know the change in PWM applied to each distinct picture, video, frame from a video and the like. Client side is less preferred as it is more exposed and requires client protection, versus, using a central server, however, client side may have a preference to reduce latency in an overall complex system.

In a related embodiment, special software module generates the PWMs which is emitted with a certain predetermined timing, a flash pattern of on off, or intensity levels (different intensities as a function, predictably and programmable(y) changing over time). These flash patterns can also be intensity patterns from low intensity to high, and may be applied to specific frequencies or images being output to then reflect back to the digital camera for superimposition over the actual image. Understanding that these PWMs are gathered with the images and videos, the emitters will be shown to be in proximity of a given camera. Hence the software which generates the PWMs can also generate a time date stamp (synchronized to a reliable clock) for each unique, novel PWM, it's sunsequent assignment to a given camera and time of day and date assigned is then stored by the software (calculated, stored and able to be queried) and thus the PWM, each being unique, is associated with each image or video and within a given video, each frame. This completes a cycle of generation of unique, novel PWMs which can be generated as frequently as needed to mark each frame of image uptake, or less frequently if desired. it may either be preferable to provide a central or, alternatively, a distributed verification system in accordance with the present invention. This system interestingly, need not be connected to the digital recording unit (DVR, Digital Video Recorder) via a communications network. The central or distributed verification system can detect presence and absence of PWMs in real time and set off alarms when the PWM anticipated is absent. The PWM in question is unique and novel enough to provide a match in a data base which calls up the very image to which it has been assigned, including down to the frame if frame by frame PWMs are a requirement. Hence, we could keep two different distinct DVR data bases. One is the images and videos with the PWMs superimposed and able to be played back. Another data base could do the same, only sort on the PWM time-date instead of the DVRs own internal time date stamp(s) or, even more interestingly, separate the PWM from the image or video and keep the two separate, able to be reliably recombined and compared to what is stored in the DVR for further proof of original image and video, assuring there is no corruption or meddling with the original images and videos, even as tight and tedious as frame by frame and pixel by pixel verification. it is preferable for the central verification system to detect and analyze the correlated PWMs by monitoring a security monitor through yet another complete digital CCTV system (for this purpose, hence the name “verification system”) to verify that the assigned monitor is actually displaying its assigned scene, through DSP techniques performed in the video controller which feeds directly to the given monitor. Usually, the digitized image or video, is received by a video processor board or memory and before it is then shared to a monitor or display, it can be digital signal processed (DSP) which as is known to those of skill, may further include artificially intelligent software.

In another embodiment, the monitors themselves either can or cannot display all the pixels making up the combined image or video with its PWMs. Logically, this means a monitor that either can or cannot display the light in the frequencies below and above the visible spectrum. This means the PWMs which are below, in and above the visible spectrum will be displayed, or on a more standard monitor, only the PWMs which are visible would be displayed.

In an embodiment, a closed CCTV system (C-CCTV) is provided to watch the monitors the security staff watch, to check and verify the PWMs are present and correct, correlated and time date correct simply by reaching into the master verification data base and performing the comparison but from a visibly acquired new recording taken from the very screen the security staff use, rather than to perform this task from any point within the cctv security system. This “wholly outside looking in” solution forces an evil doer or public enemy to have to hack two systems at once, to eliminate the real time alarms and divert the security staff from true images. We also provide redundancies with intrusion detection so that the evil doer would then have to simultaneously cut into 4 different places, also knowing the very next encrypted PWM. Since the closed CCTV system (C-CCTV) is ideally not on any network at all, this makes it very difficult for the public enemy or hacker to surprise the system, overall, and divert the security staff to false imagery or video shots. it may be preferable for the central verification system generate an audit trail data base, however, the main thrust of the invention is to provide automated, intelligent and real time event alerts so the evil doer and public enemy will be thwarted in real time and not get away with any trickery or diversion.

In an exemplary embodiment, in order to cost effectively address several security hardening aspects of the invention, a wireless router is proposed for inclusion side by side with the active components of a digital camera, within its housing and with the opportunity to share any hard wire data transfer connections and power sources. This means, to cut costs, the camera and its router can share the hard wire connection to independently send data across the data medium the wire represents (eg Cat 5, Cat 6, 10 Base T, 100/1000 Base T, Giga speed) Also, it is preferred that the camera have a short life battery internal to its housing to allow the router and the camera to continue to operate, even if all lines to the device are cut or tampered with.

Yet another embodiment allows the router to be a Wi Fi and to generate multiple Wi Fi connection types which work simultaneously.

It may be preferable to allow each router to have a hard partition within which it is impossible to log new devices once a technician sets the router to allow certain allowed devices to communicate through the router in wireless format(s). The camera may pass intrusion data to the router to transport to a security center, monitoring stations, software equipped to receive the intrusion information and generate necessary alarms.

It is preferable to add a light source to the camera which can be independently addressed and controlled apart from the router or the camera.

It is preferable to include light sources within the CCD chip of the camera, the very element which converts analog images (photons) to voltage values and then to data, may also emit light and do so in patterns, with an array that is independently addressable pixel by pixel and may include light below the human visible range, through the visible range and above the visible range. This may take advantage of analog lenses, pinhole lenses and photonic wave guides to accomplish certain technical feats.

It is preferable to cause either a simple “verification light source” or the more complex integrated CCD chip light source to emit patterns which are then timed to be captured by way of reflection off of the objects in the field of view of the camera for conversion to digital data which is then transported as with other digital CCTV type cameras over the available transport media (wire, fiber, wireless or combinations of these).

Another embodiment causes each camera to send its video or still image in full, through a primary pathway and again, over a secondary pathway or more than two pathways in whole, or in part, with or without further encryption but with software present at the opposite end or ends to generate a final verified image or video with the intact ability to identify and trip any needed alarms.

Another embodiment allows the received images or videos to be cross compared for differences, where there should be no difference in a redundant image received and if there were, an alarm would be recognized, set and identified to the users of the system in real time. A central database is constructed which records what light patterns were sent to which light emitters according to a very accurate clock and high reliability synchronization of all elements of the system. The system should use modern methods to assure all devices have accurate synchronized time recorded wherever there is an internal clock (eg in the camera element, in the router, in the light emitting devices). Each still image or video image can be split into an image devoid of the light pattern and the reflected light pattern itself can be stored in its own related file for each still image or each frame of each video recording.

It is preferable to provide an “Al” like software to alert users that an image or frame was received where the light pattern co-recorded, separated and compared to what the central data base knows should be the pattern, varies too far from the required settings to be “authentic” causing the users to question the authenticity and determine why the still image or video failed to pass this test. One answer could be, an object was introduced within the field of view which substantially altered the image thereafter, such as hanging a large mirror in the field of view, or a hanging planter very close to the camera lens. At first, this would trip settings which decide that in the field of view, too much percentage of pixels where the light patterns were reflecting (refracting, diffracting, scattering, entangling), have changed. The users then decide what the change means and can tell the system to allow only once, or, change settings to allow the new object in the field of view to stay in its place and no longer give false triggers. Eg once its there, and it has changed the pattern substantially, it may stay if the override is pressed once, because the maximum change to net sum pattern received has already happened and the mirror is now stationary. Another event could be a large mobile cleaning machine which reflects so much of the “verification light source” as to cause the alarm each time the cleaning machine enters the field of view. In an embodiment, to inhibit this event, again the “Al” software is programmed to identify the object and track its use and pattern so as to suppress alarms when the machine is in use but only the alarms raised by the machine's presence in a field of view.

It is preferable to place cameras in strategic locations so as to monitor one another by way of line of site. Another embodiment mandates the use of camera placement so as to generate a mesh of cameras which monitor one another through line of site so that no single camera is ever not in the line of site of another. It is preferable to place cameras so each camera is in line of site of at least 2 other cameras. It is preferable to prove the image a security station is receiving on its monitor, is congruent with the image the actual camera captured. To do this, a high rate of speed “digital verification camera” may be placed behind and in line of site contact with the monitor or monitors so that the image this particular camera captures is clear and precise enough for the image to be cross compared to the image the remote digital camera captured and transported to the monitoring station and to all of the recording devices. A 60 HZ refresh rate on a monitor normally causes digital and analog cameras to record images of the display surface which are unintelligible. Through synchronization of the timing or a vast increase in the sampling rate, this issue is completely overcome and perfect duplicate images can be copied from the monitoring screen by the digital verification camera, then processed in a new network (verification network) cross compared to the cctv security network and if there is a failure in congruence, an alarm can be set.

All of the herein contained embodiments can equally apply to the digital verification of images or videos taken by other cameras such as stand-alone portable cameras or that which a portable device may contain as a side benefit, such as a cell phone, tablet or laptop PC. Digital verification cameras could be wireless devices worn by security staff as wearable electronics, such as head set, glasses or clip on. There are two uses of the term “pattern” which effect context of the embodiments. Both may be implied in accordance with the context of the embodiment. One is the actual light pattern in terms of a still image made of light. An example would be a logo, and this includes mixing colors in the pattern image all inclusive, below, within and above the visible spectrum. Another is the on off pattern of each pixel or verification light source, which may be coded and unique, non repeating but known to a central data base as to the moment of its creation, its pattern as displayed and its pattern as a function of time (pattern in this specific sub context meaning on off per pixel or per light source including non digital light sources, which could be optionally used) to be used as a form of visual water mark. Visual means visual in terms of any means to “see” the patterns, even when they are not visible to human eyes, due to the fact that the software (digital signal processing) can see all light patterns and alert the user if there is any significant event determined by any aspect of the pattern, its presence, absence or failure to be congruent to an anticipated pattern based on the real time stamp of the event, image or video in question.

In another embodiment, light sources which emit dual color or multi color in known spectral breakdowns are used to further complicate the reflected, refracted, diffracted, scattered or entangled composite image. In another embodiment, the light source could approach the complexity of or literally be a digtal projector, allowing for a vastly complex photonic signal and pattern inclusive of individual pixels being turned on, off, their intensity being altered per predefined scope of the predetermined PWM. In another embodiment, the light source approaching or approximating the function of a digital projector, could be built in to the same CCD chip as the camera functions upon, and this general idea is covered in the figures below.

In an embodiment, the mesh wire patterns and wifi connectivity can be creatively used as shown in figures, to send redundant data streams from any camera to any camera and to the central DVR. The use of frames within the digitzation standards are useful and these are discussed in the figures below. However, the invention is not intended to be limited to the use of standardized methods of sending digital data from cameras to DVRs and explicitly, the invention can support the idea of splitting frames and even splitting sets of pixels down to individual pixels for further encryption and creative use of the connectivity means to reach the necessary elements to function as a complete CCTV system. In so doing, with the topology set to instantly detect intrusion or a cut of a line (or disconnect) these extra means of encryption ensure more rapid detection means and act as a further thwart to intrusion in a maximally secure CCTV deployment using these embodiments. Nothing herein is intended to limit or preclude known and unknown use of encryption, digital data standards for movement of data, and creative use of any and all pathways provided to help improve the impregnability, security, assured certification of real, live image and all other aspects of the invention.

In an embodiment, TDR (Time Domain reflectometer and OTDR (Optical Time Domain Reflectometer) functionality in the form of scavenging (scavenging power and out of band or in band signal) microchip sets may be built into the outputs and inputs of each hard wire (or fiber) connection, allowing for accurate measurement of the length of each piece of wiring. This testing can be implemented to run continuous, so as to thwart any attempt to bypass a wire or fiber segment. The wireless routers may also be equipped with rfid technology or other distance or auto location gauging technology so as to allow for the routers, once installed and set for operation, to be able to produce an alarm for any significant movement of any one router relative to the others. The camera mount which is able to be re-adjusted to change the primary view angle of the camera may be equipped with a position sensor, reporting any attempt to re-position the camera at any time. Even the central control elements of the system, essentially all pieces, could be similarly equipped and wired (or fiber connected) to protect from any manipulation of any element. These additions assist in utterly securing the physical aspects of the system. When technicians first install a system or attempt to rearrange a system, these elements will raise alarms unless the technician first orders the system to allow the specific change or ignore alarms on a segment or a system component. The system shall restore the segment automatically in a certain time frame when the command is entered to ignore a segment, to assure the technician does not omit the restoration, or the owner of the system can set the system to not allow this blocking, raising alarms whenever a technician implements temporarily disruptive change which raises and holds these forms of alarm(s) until the segment is put back into service. To harden other elements, any possible piece of add-on hardware, wire or fiber, could be similarly equipped which may include memory sticks or chips put into the system, batteries and battery back up systems, keyboards, mice, displays, display adaptors each intending to shut out loopholes where a public enemy or wrong doer could intrude into the system. To set a unique identifier or encryption key into a new piece of hardware, the central equipment may be under lock and key, could be required for access to connect up the new piece of equipment and then “burn in” as a one time event, the new identifiers. This way, for a wrong doer or public enemy to create a piece of equipment that can be attached to the system, they first have to have access to this secure (physically secure, as under lock and key) central piece of equipment, typically a server serving as a verification server, DVR or both. In yet a deeper hardening step, the unique identifier added in will be limited as to its life, so the technical person or user setting the unique id into the component then must get the component to its position and put it in service, or the main system will lock out that piece of equipment until a new unique identifier is set into the item in question. If too many items are attempted to be attached in succession, yet another alarm can trip and no new additions will be allowed. This thwarts hackers who feel they are going to sneak past this element through a rapid trial and error approach.

In an embodiment, artificial intelligence and artificially intelligent software could be deployed into all elements with emphasis on the DVR, for analysis of patterns from which any break in the pattern could indicate an attempt at clandestine intrusion. An example would be to apply pattern analysis to static video images inclusive of the PWM, to assure change in viewed elements are not part of a manipulation scheme to mask an attempt to alter, steal, replace or counterfeit any object in the field of view or commit any form of undesirable act without the security guard and the recorded image catching the event. The PWM data is unchanging during this artificial intelligence analysis, hence its constant presence acts as a watch dog feature. The critical elements, such as a camera, could be equipped with biometric and multibiometric elements capable of sensing the unique identity of the technician or a card (or app in a cell phone) the technician carries. The device could raise alarms and permanently turn on an alarm to indicate an unidentified attempt to tamper or, an unauthorized user who attempted to tamper with, remove, replace or adjust a given piece of the system, such as a server, camera or any other critical element we wish to equip in this manner. The bio sensor(s) could be a small portable device which attach(s) to the system element to temporarily provide the bio sensor array for the device to keep costs down. Cell phones using NFC(s) could perform this task. The communications protocol between any of these portable devices and the fixed elements of the system could use industry standard or proprietary programs which further harden and protect the handshake and data passage elements of the biosensor attachment to any given device.

In an embodiment, a camera equipped with PWM detecting technology, the ability to “see” the PWM, can also use the same detecting technology to read a device capable of emitting PWMs or other photonic data carried on the person of individuals who pass through these various fields of view a camera will “see” per its domain or anticipated field of view. Emission of a PWM is not intended to be exclusively limited to things people carry or, reflections from objects in a field of view. Objects in a field of view could also be equipped to communicate with the verification server and emit deliberate PWMs that are unique per unit of time, to be received by any camera(s) in the associated line of sight. These additional objects in a field of view could be light fixtures, smoke and fire detectors, motion detectors, break in detectors, glass break detectors, chemical detectors, other electronic and sensor type devices to thwart any attempt to either add fake items of this nature to a premises, or, swap out, modify or bug” any item in a field of view. As such, the central equipment can be equipped with software to attempt to identify the identity of each individual person or mammal (living creature) and object with emphasis on electronic objects, in its field of view and any device a person or mammal (animal, robot) may be carrying. If the portable device carried by a human, animal, robot or drone emits data that uniquely identifies the device, that information can be cross referenced to the video derived identity of the individual carrying the device to then draw an automated conclusion and assign a certainty (weight or factor) such as “individual X, identified with 99.99% certainty just through video analysis is carrying device Y with 100% certainty as to the unique device” and the PWMs further provide the specific camera, date, time, that a PWM and all other elements appeared to have not been tampered with 99.9999% certain for the given image, video segment or stored recording.

Recordings made which can include the certainty factor assigned to elements, such as a fixed scene, a changing scene, authorized people or animal(s) movement, unauthorized actions or activities, technician activities can then be assigned a certainty factor and automatically order historic or real time events for review by a security office, so the events of a given day can be reviewed either as they unfold, or in arrears. Because security staff are typically assigned more than one camera to be responsible for, these automations assist in making certain human eyes are put upon any suspicious activity more so than activities which are less suspicious or not suspicious at all. A video of a technician who forgot a protocol and tripped an alarm would be assigned a 100% certainty as to unauthorized action, and the action could be deemed “maximally suspicious” even though it does not mean the technician's mistake was an deliberate attempt to intrude. This weighting for all recorded images provides critical information and it should always be considered one of the best ways to try to defeat this system is through an existing technician, by gaining his/her complicity, commonly referred to as an “inside job”. If the cards or apps the technicians carry can sense biometrically, the level of nervousness of the individual, that can be included in the certainty factor for weighting elements. This can apply to any and all staff who have anything at all to do with the use of the system.

To provide more use of the DVR, the concept of access controls could be added to the DVR such that access points on a security system can be integrated into the DVR function wherein, users who, in order to gain access to an area, must input data using a portable device that provides biometric or multibiometric data, to open an egress or ingress apparatus, will be assigned a certainty factor associated with their identity and the identity if their biometric device, which then couples to the certainty factor and identity factors the DVR applies to the recorded and real time images.

This cross integration couples the DVR to the access control system(s) to provide certainty as to the identity of people or animals in the field(s) of view, and then assign risk percentages to events and each individual person or animal in an event, so a security guard can constantly have “eyes on” the events and individuals most suspicious. This part of the system can be a toggle, wherein its always on, but displaying the data in real time or during a recording review, can be turned on and off. The certainty factors can be tied to the individual people or animals in a given scene, with movable animations that attempt to avoid overlap and show the tie to the individual graphically, as well as the certainty factor the individual or animal was generating at the moment in question. If every person or animal had a device which measures their biometrics (or multi biometrics) and from these data the degree of mood or nervousness could be passed, then individuals in a crowd could be singled out and identified as to their potential threat level. The access controls are also subject to emitting PWMs on their own, so a public enemy or wrong doer does not try to replace or tamper with these types of electronic systems and their peripherals.

The verification server generating the PWMs, which serve as unique identifiers for a frame of an image or a still image, may correlate each unique generated PWM with a specific time, date, device to receive the PWM and as such, when a later query is made of the data base in the verification server, the server can conduct a search of its content and find an identical match. Given the complexity of the PWM is intended to be uniquely identifiable, the time, date, image or frame of an image and device will be identified purely through analysis of only the PWM data removed from the image (or frame of a video) and processed as a pattern search. The pattern can be one of photonic color, entanglement data, polarization, intensity, on off blink patterns and may also exhibit monochrome attributes as well as multi-color, either as a single beam or as a projected image. The quantum entangled data may also provide yet another layer of data which may include time, date, device through which the quantum entangled data was directed and device intended to receive the PWM with quantum entangled data. eg digital projector 2234 projecting a PWM xxxxx could be one device, and “Camera 144” could be the intended receiving device.

All devices making up a system, including access devices, sensors, fire detect, smoke detect, camera, server, video monitor, peripheral such as a mouse, memory stick, down to the smallest logical common denominator, may be equipped with NFC (Near Field Communications) RFID (Radio Frequency Interface Device) and GPS (Global Positioning System) or GPS substitute technology. The combination of PWM and these aforementioned locating technologies provided in each piece of a system, allows for registration during initial installation thus assuring that to swap out or intrude upon, clandestinely or intentionally, any one component of the system, the operators of the system will be alerted to the change. These pieces making up a system are continuously in communication with one another, ideally, with battery support built into cameras which the switches and routers found inside the cameras may operate from during power failure, thus assuring there is simply no moment of less protection in a given system opening it up to a quick intrusion or clandestine plant of electronics which are intended to thwart the function and security of the system. One of skill will readily recognize, the addition of any one component requires the logging and registration of location provision mechanisms such as GPS, any unique identifier the hardware provides during handshake, and then, an anticipated PWM must appear in the device, if it is in the field of view of a camera. Hence, three levels of protection are provided so a clandestine device may not be attached or, an existing component may not be undesirably altered, modified or tampered with during operation.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

Individuals of skill, once reviewing this invention with particularity to the network structures, isolation of certain servers, use of software and placement of legacy and new devices, will see there are further permutations in practicing the use of these teachings. Accordingly, not every possible use or layout is shown, yet the invention is applicable to any and all cctv settings currently in use.

1. A method for verification of a digital image
in a camera security system monitoring at least one area by at least one video camera device connected to a network, monitor and processor, the method comprising;
incorporating a superimposed image having a distinguishable and difficult to imitate characteristic into the content captured by said camera, operating, at least a portion of the time, in at least one normal mode of operation-monitoring for at least one fault condition related to said superimposed image; and
entering a fault mode of operation upon detecting said fault condition.

2. The method of claim 1 wherein said characteristic comprises a photonic water mark (PWM) pattern produced by a verification source of electromagnetic radiation projected into the area monitored by said camera and wherein said step of monitoring for at least one fault condition comprises calculating the presence of or absence of the PWM.

3. The method of claim 1 further comprising
performing a target detection operation using a second camera device during said normal mode of operation to verify detection of a target by one of said at least one first camera devices prior to a guard interface unit being notified of the detection of said target by said first at least one camera devices;
controlling said second camera device to monitor the area which was being monitored by said at least one first camera device corresponding to the detected fault condition.
wherein said characteristic comprises an image electronically inserted said into the actual source of the picture or video.

4. The method of claim 1 wherein said characteristic comprises
swapping frames in a randomized but recorded order and wherein said characteristics serve as unique identifiers for a frame of an image image.

5. The method of claim 3, further comprising detecting the presence of a moving target in the area being monitored by the first camera device.

6. The method of claim 2 or 3 further comprising;
providing duplicate pathway pairs by duplicating elements of the security system selected from the list of camera, switch, router, feed line, projectors emitting PWMs, wi-fi connections,
routing video through duplicate pathway pairs comprising said duplicated elements.

7. The method of claim 1 further comprising;
displaying said video on monitors having a selective ability to display all the pixels making up the combined image, wherein said ability depends on the pattern of said characteristic.

8. The method of claim 2 further comprising;
correlating each unique generated PWM with a specific time, date, device to receive the PWM and as such, when a later query is made of the data base in the verification server, the server can conduct a search of its content and find an identical match. Given the complexity of the PWM is intended to be uniquely identifiable, the time, date, image or frame of an image and device will be identified purely through analysis of only the PWM data removed from the image (or frame of a video) and processed as a pattern search.

9. The method of claim 8 wherein said pattern comprises characteristics selected from the list of photonic color, entanglement data, polarization, intensity, —timing of the PWM.

10. The method of claim 6 further comprising;
generating a tampering alarm in the event that video passing through any one of said duplicate pathway pairs is different.

11. The method of claim 5 further comprising a step of GPS locating of the target.

12. The method of claim 9 further comprising digitally combining characteristics selected from said list below or above the visible spectrum, in spectral regions to which CCD or CMOS chips respond with the object or scene image

13. A closed CCTV system (C-CCTV) to watch, check and verify the monitors watched by security staff operating the system of claim 1, correlating data pertaining to said characteristic with a master verification data base.

14. A hand held portable device connected to the system of claim 13 and displaying said PWM data 410.

15. The hand held portable device of claim 14 further comprising software and hardware adapted to detect the presence or absence of the PWM and to verify for authenticity with a server.
